(19) United States
(12) Patent Application Publication
(10) Pub. No.: US 2017/0300967 A1
(43) Pub. Date: Oct. 19, 2017

(54) SATELLITE-BASED COMMUNICATION NETWORK FOR REDUCING BANDWIDTH USE AND COMMUNICATION LATENCY

(71) Applicant: Hughes Network Systems, LLC, Germantown, MD (US)

(72) Inventors: Emanuel HARRINGTON, Bowie, MD (US); Frank LI, Herndon, VA (US)

(21) Appl. No.: 15/087,362

(22) Filed: Mar. 31, 2016

(51) Int. Cl. G06Q 30/02; H04B 7/185; H04L 29/08

(52) U.S. Cl. CPC G06Q 30/0255; H04L 67/2842; H04L 67/02; H04B 7/18526; H04B 7/18584; H04B 7/18593

(57) ABSTRACT

A communication network, such as a satellite-based communication network, comprises a gateway transceiver that communicates with a plurality of remote locations via the communication network, and a gateway controller which operates to generate website content data based on website data for a website and link accessible data at the website. The gateway controller further operates to control the gateway transceiver to transmit the website content data to the plurality of remote locations via a broadcast communication. Thus, bandwidth usage to provide the website content data to multiple remote locations is reduced. Also, the network terminals at the remote locations make the transmitted website content data available locally without the need to establish a communication link with the gateway transceiver, thus reducing latency in providing the content.

### BACKGROUND

### Field of the Invention

The present invention generally relates to a communication network and, in particular, a satellite-based communication network for reducing bandwidth use and communication latency. More specifically, the present invention relates to a satellite-based communication network that transmits web page content to user terminals based on popularity related conditions to enable the user terminals to locally provide the web page content without accessing the network.

### Background Information

Communication networks, in particular, satellite-based communication networks experience may inherent delays or latency when accessing and providing web page content to users requesting the content. Much of this latency is due to the time required to transmit signals back and forth to a satellite when accessing the web page content and providing the content to the requesting users. For example, when a satellite user terminal requests web page content via, for example, a graphic user interface (GUI) such as a web browser, the satellite user terminal transmits a request for the web page content to a satellite which, in most cases, transmits the request to a gateway, which can function as a network operating center. The network operating center then routes the request to the content provider site which provides the web page content. The content provider site then sends the web page content to the network operating center, which transmits the content to the satellite for delivery to the requesting satellite user terminal.

In an attempt to reduce delay caused by these communications via the satellite, satellite user terminals can be configured to store or cache information locally. For example, when a satellite user terminal requests a webpage, data associated with the web links that are embedded in the webpage are downloaded from the satellite and cached locally at the satellite user terminal. This allows webpages to load more quickly at the satellite user terminal when a user clicks on a link displayed on a GUI that are embedded in a webpage that has already loaded. This type of embedded web link caching is present in the TurboPage® technology as developed by Hughes Network Systems, LLC.

Although the TurboPage® technology is effective in caching embedded web link content, the technology does not cache web link contents that are not embedded in the downloaded webpage. Also, the TurboPage® technology operates to transmit the same data to each satellite user terminal individually upon receiving a request from a satellite user terminal. Such multiple transmissions between the network operating center, the satellite and the satellite user terminals for each satellite user terminal request can result in slower browsing due to latency as discussed above, as well as reduced satellite bandwidth during peak hours of usage.

### SUMMARY

In view of the above drawbacks associated with the existing technology, exemplary embodiments of the present invention provide a communication network and, in particular, a satellite-based communication network that is more effective in reducing bandwidth use and communication latency. These embodiments employ a gateway that operates to transmit website content via a broadcast communication to multiple satellite user terminals that are most likely to request such webpage content. The satellite user terminals therefore store this webpage content locally in a memory, and provide this webpage content locally. Accordingly, bi-directional communication between the network operation center, the satellite and the user terminals can be reduced, which reduces latency and improves bandwidth efficiency of the communication network.

An exemplary embodiment of a communication network described herein comprises a gateway transceiver configured to communicate with a plurality of remote locations via the communication network, and a gateway controller configured to operate to generate website content data based on website data for a website and link accessible data at the website. The gateway controller is further configured to operate to control the gateway transceiver to transmit the website content data to the plurality of remote locations via a broadcast communication. Since website content data is distributed to numerous remote locations, such as numerous satellite user terminals, via a single broadcast, bandwidth usage is reduced. Also, because the satellite user terminals store the transmitted website content data, the satellite user terminals can make that website content data available to a requesting user without the need to establish a communication link with the gateway transceiver to request that specific content, thus reducing latency in providing the content.

### BRIEF DESCRIPTION OF THE DRAWINGS

Referring now to the attached drawings which form a part of this original disclosure:

FIG. 1 illustrates an example of a satellite communication network according to a disclosed embodiment;

FIG. 2 is a flowchart illustrating an example of operations performed by the controller of a gateway of the satellite communication network according to a disclosed embodiment;

FIG. 3 is a diagrammatic view of example of a database created by the controller of the gateway according to the operations performed in the flowchart of FIG. 2;

FIG. 4 is a diagrammatic view of an example of a webpage who content and link accessible content is retrieved by the controller of the gateway according to the operations performed in the flowchart of FIG. 2;

FIG. 5 is a flowchart illustrating an example of operations performed by the controller of the gateway to collect advertising content according to the operations performed in the flowchart of FIG. 2; and

FIG. 6 is a flowchart illustrating an example of operations performed by the controller of a satellite user terminal of the satellite communication network according to a disclosed embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

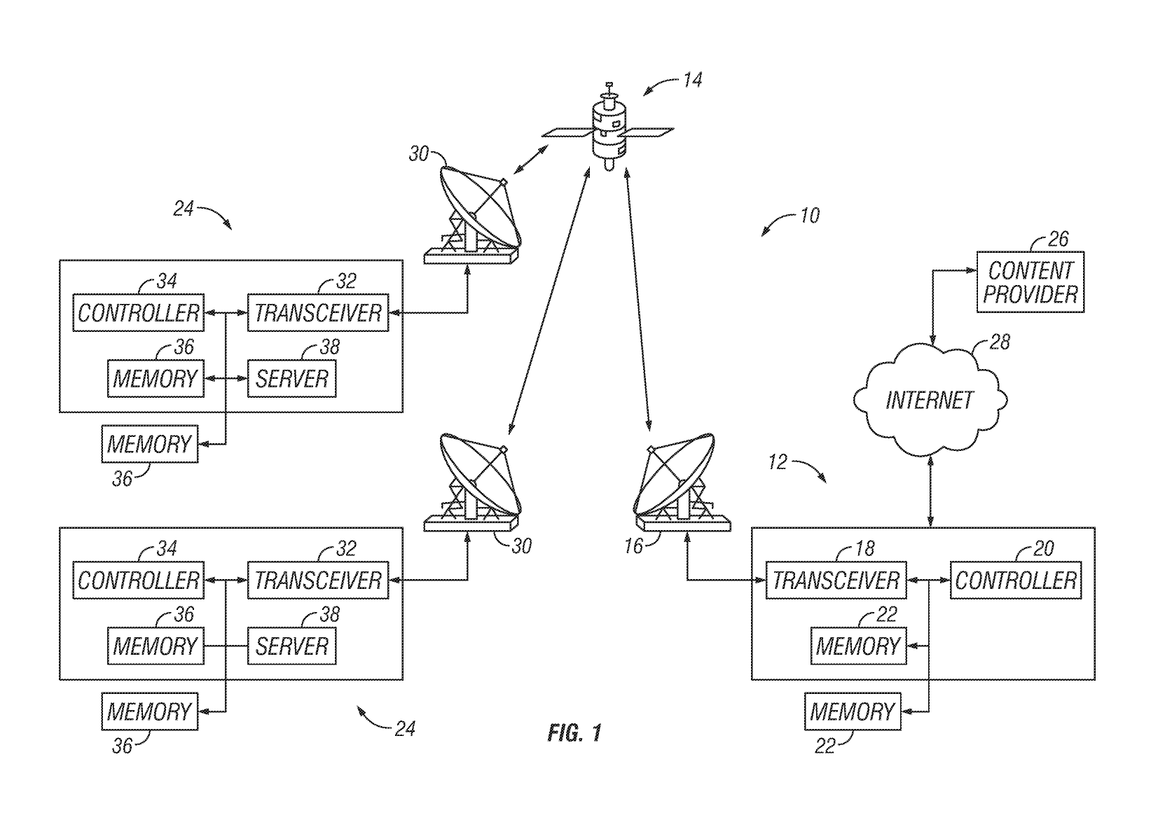

FIG. 1 illustrates an example of a satellite communication network 10 according to an exemplary embodiment. A satellite communication network 10 typically includes a plurality of terrestrially mounted gateways 12 that communicate with one or more orbiting satellites 14. Each satellite gateway includes an antenna dish 16, a transceiver 18, a controller 20, a memory 22 and other types of equipment (not shown) such as amplifiers, waveguides and so on as understood in the art on which enable communication between the gateway 12 and a plurality of satellite user terminals 24 via one or more of the orbiting satellites 14. The memory 22 can be, for example, an internal memory in the gateway 12, or other type of memory devices such as flash memory or hard drives with external high speed interface such as a USB bus or an SATA bus, or remote memories such as cloud storage and so on. These other types of memory can be present at the gateway 12 or accessible at a location apart from the gateway 12 via a network connection such as an Ethernet connection, a WiFi connection or any other suitable type of connection as understood in the art.

As understood in the art, the controller 20 preferably includes a microcomputer with a control program that controls the gateway 12 as discussed herein. The controller 20 can also include other conventional components such as an input interface circuit, an output interface circuit, and storage devices such as a ROM (Read Only Memory) device and a RAM (Random Access Memory) device. The RAM and ROM store processing results and control programs that are run by the controller 20. The controller 20 is operatively coupled to the components of the gateway 12 as appropriate, in a conventional manner. It will be apparent to those skilled in the art from this disclosure that the precise structure and algorithms for the controller 20 can be any combination of hardware and software that will carry out the functions of the present invention.

The gateway 12, satellites 14 and satellite user terminals 24 typically communicate with each other over a radio frequency link, such as a Ku-band link, a Ka-band link or any other suitable type of link as understood in the art. Also, one or more of the gateways 12 can be configured as a network management center or network operating center which, among other things, operate to communicate with remote sites, such as web content providers 26, via the Internet 28, cloud storage, or other communication networks as understood in the art. In addition, the gateways 12 can communicate with each other via, for example, the Internet 28 or other communication networks.

As further shown in FIG. 1, a satellite user terminal 24 typically includes an antenna dish 30, a transceiver 32, a controller 34, a memory 36, a local server 38 and other types of equipment (not shown) such as amplifiers, waveguides and so on as understood in the art on which enable communication between the satellite user terminal 24 and one or more gateways 12 via one or more of the orbiting satellites 14. A transceiver 32 can include, for example, an integrated satellite modem and any other suitable equipment which enables the transceiver 32 to communicate with one or more of the orbiting satellites 14 as understood in the art. The memory 36 can be, for example, an internal memory in the satellite user terminal 24, or other type of memory devices such as a flash memory or hard drives with external high speed interface such as a USB bus or an SATA bus, or remote memories such as cloud storage and so on. These other types of memory can be present at the satellite user terminal 24 or accessible at a location apart from the satellite user terminal 24 via a network connection such as an Ethernet connection, a WiFi connection or any other suitable type of connection as understood in the art.

As with the controller 20 for a gateway 12, the controller 34 preferably includes a microcomputer with a control program that controls the satellite user terminal 24 as discussed herein. The controller 34 can also include other conventional components such as an input interface circuit, an output interface circuit, and storage devices such as a ROM (Read Only Memory) device and a RAM (Random Access Memory) device. The RAM and ROM store processing results and control programs that are run by the controller 34. The controller 34 is operatively coupled to the components of the satellite user terminal 24 as appropriate, in a conventional manner. It will be apparent to those skilled in the art from this disclosure that the precise structure and algorithms for the controller 34 can be any combination of hardware and software that will carry out the functions of the present invention.

Examples of operations performed by the satellite communication network 10 to deliver website content to satellite user terminals 24 will now be described with regard to FIGS. 1 through 5. Also, even though the operations are described in these examples with regard to a satellite communication network, these operations could be performed by any type of communication network as understood in the art.

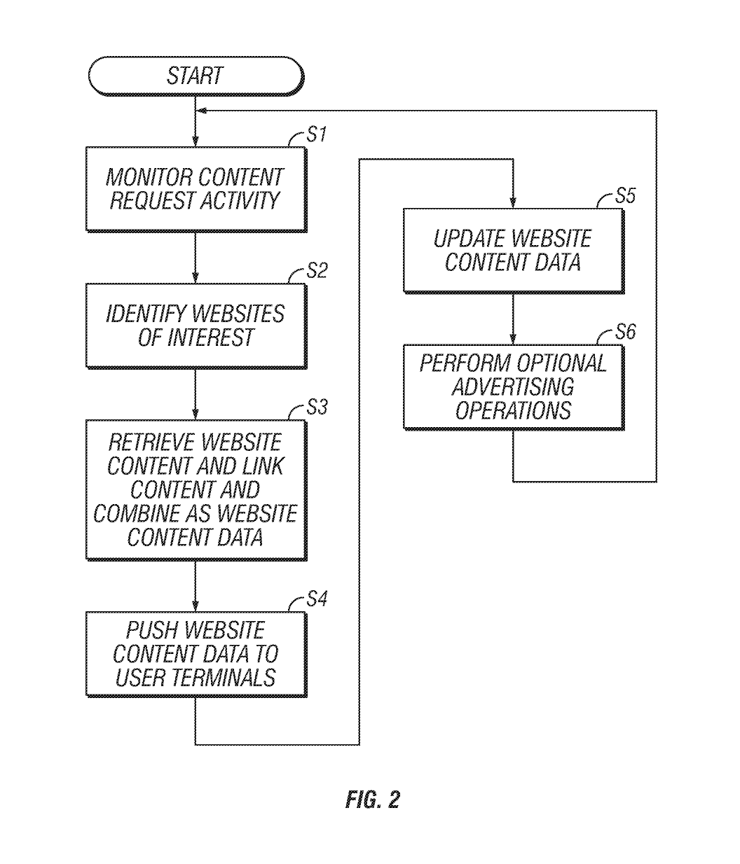

As shown in the flowchart of FIG. 2, when the processing begins, the gateway 12 monitors the web surfing habits of numerous satellite user terminals 24 in step S1. That is, when a satellite user terminal 24 requests web page content via, for example, a graphic user interface (GUI) such as a web browser, the controller 34 controls the transceiver 32 of the satellite user terminal 24 to transmit a request for the website content (e.g., a webpage, information associated with a link on a webpage, and so on) to a satellite 14, which transmits the request to a gateway 12 operating, for example, as a network management center. For purposes of the description herein, the terms “website” and “webpage” may be used interchangeably to refer generally to web-based content as understood in the art. Also, the term “link” on a webpage or website as used herein generally refers to a type of hyperlink to additional content as understood in the art.

The controller 20 controls the transceiver 18 of the gateway 12 to receive the request from the satellite 14. The controller 20 controls the gateway 12 to route the request to the content provider 26 via, for example, the Internet 28 or other communication networks in any known manner as understood in the art. The content provider 26 provides the website content to the gateway 12 in any suitable manner as understood in the art, and the controller 20 controls the gateway 12 to store the website content in the memory 22 or at some other suitable location. The controller 20 also controls the transceiver 18 to transmit the content from the gateway 12 to the satellite 14 for delivery to the requesting satellite user terminal 24. The controller 34 of the satellite user terminal 24 controls the transceiver 32 to receive the content from the satellite 14, and controls the memory 36 to store the content. The controller 34 thus further controls the satellite user terminal 24 to provide the content to the user who can view the content on, for example, a GUI as understood in the art.

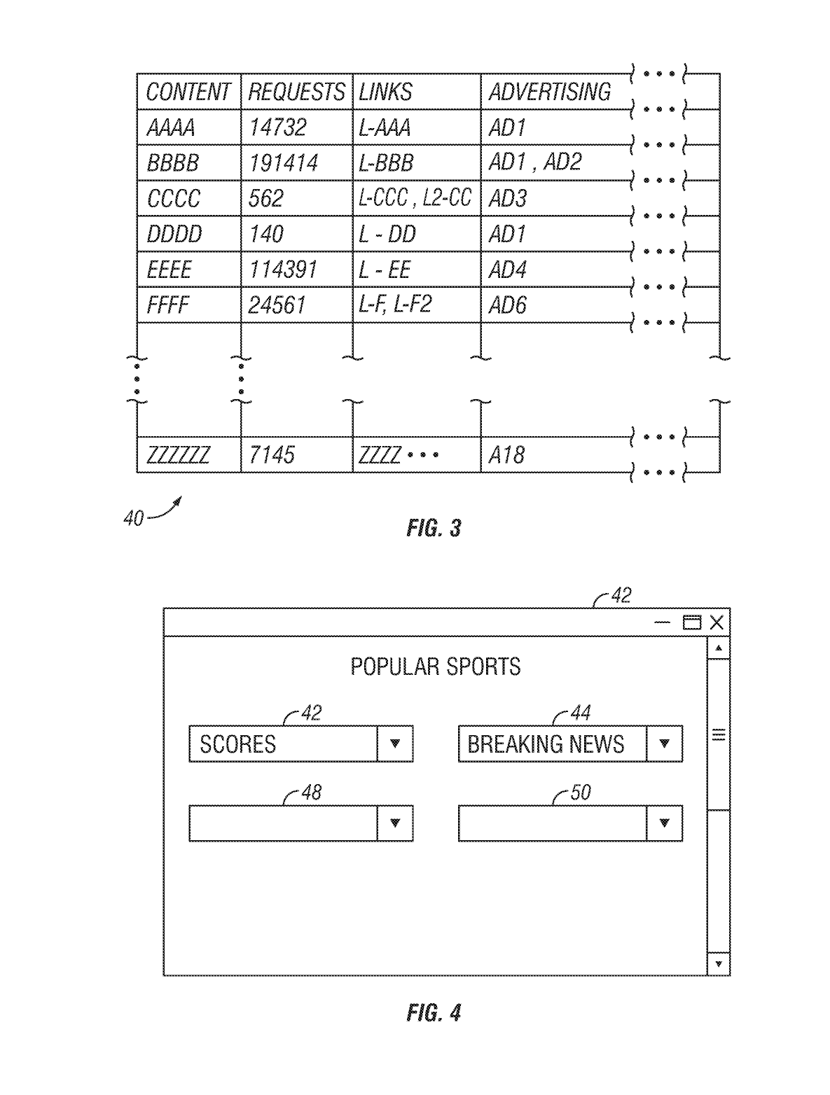

Thus, in step S1, as the gateway 12 receives these request for website content, the controller 20 monitors these requests from the satellite user terminals 24 and maintains in the memory 22 an ongoing database 40 which includes, for example, identification information pertaining to the websites and contents of the websites, including information pertaining to links present on the websites, and information pertaining to the number of requests for the contents of the websites. An example of information contained in the database 40 is shown in FIG. 3. Also, for each request received, the controller 20 also stores in the database 40 user terminal identification information which identifies the respective satellite user terminal 24 from which the request was received, location information (e.g., longitude and latitude information, zip code information, local broadcast region information, and so on) pertaining to the respective satellite user terminal 24, request history indicating a history of website requests from the respective satellite user terminal 24 for at least a period of time, and so on.

The controller 20 continuously monitors and updates the database in real-time or substantially in real-time in response to the requests from the satellite user terminals 24. Furthermore, the controller 20 can analyze the information in the database 40 based on any suitable criteria, such as by individuation locations of the satellite user terminals 24, geographic locations in which the satellite user terminals 24 reside, respective website request history of each satellite user terminal 24, date of website request, day of website request, time of day of website request, and so on.

Therefore, in step S2, the controller 20 analyzes the information in the database 40 and identifies websites that meets a popularity condition based on information pertaining to requests for access to website data present at the website. In the examples discussed herein, the term “popularity condition” generally refers to an indication of the popularity of a website, or the popularity of specific content on a website or content accessible via a link on a website. For instance, the term “popularity condition” can refer to a number of requests for a particular website or for content on that particular website, or content that is accessible via a particular link on that particular website. Thus, when analyzing the database 40, the controller 20 can identify those websites for which the most requests have been received by the gateway 12 from satellite user terminals 24. The term “popularity condition” can also refer to certain known popular websites, such as popular news websites (e.g., CNN, MSNBC, FOX and so on), popular sports websites (e.g., ESPN), popular weather websites (e.g., the Weather Channel) and so on. The term “popularity condition” can further refer to websites for which individual satellite user terminals 24 have requested periodic updates of the contents of those websites via, for example, a GUI or in any other suitable manner.

In step S3, the controller 20 controls the gateway 12 to retrieve from the respective the content providers 26 the website content of those websites which the controller 20 identifies as meeting the desired popularity condition. For instance, the controller 20 can retrieve the website content of the respective websites that have received a respective number of requests at least equal to a predetermined threshold. The controller 20 can, in addition or alternatively, retrieve the website content of the respective known popular websites. Furthermore, the controller 20 can, in addition or alternatively, retrieve the website content of the respective websites for which periodic updates have been requested from specific satellite user terminals 24.

In step S3, the controller 20 also controls the gateway 12 to retrieve from the respective content providers 26 link accessible data that is otherwise retrieved via a weblink at a website meeting the desired popularity condition. Since it is common for a website to include links to information which may be of further interest, the controller 20 analyze the information in the database 40 to determine which of the links on a website meeting the desired popularity condition link to content that also meets the desired popularity condition.

For example, as shown in FIG. 4, a popular sports website 42 may include several links such as a link to the latest major league baseball scores 44, a link to breaking sports news 46, and other specialized links 48 and 50. Upon determining that the content which is accessible via any or all of these links 44 through 50 meets the desired popularity condition, the controller 20 controls the gateway 12 to retrieve that link accessible data from the respective content providers 26. For example, if the controller 20 determines that users at many satellite user terminals 24 are clicking on the link to the latest major league baseball scores 44 and are thus requesting that content, the controller 20 will retrieve that link accessible data pertaining to the latest major league baseball scores from the respective content providers 26. Likewise, if the controller 20 determines that users at many satellite user terminals 24 are clicking on the link to the breaking sports news 46 and are thus requesting that content, the controller 20 will retrieve that link accessible data pertaining to the braking sports news from the respective content providers 26. The controller 20 will thus combine the link accessible data with the website data to create respective website content data for each respective website that meets the desired popularity condition. Therefore, each website content data includes not only the content present on the website, but content that is accessible via a link or links on that website.

In addition, during step S3, the controller 20 can further include encryption information in any or all of the website content data to restrict access to any or all of the website content data by the satellite user terminals 24. For example, if certain streaming content, such as particular movie or television program, or any other type of third-party applications, software, data, multimedia and so on, is receiving many requests, the website and/or link to the streaming content may meet the popularity condition. However, the streaming content may be a pay-per-view type movie or program. Therefore, the controller 20 will retrieve the entirety of the streaming content from the content provider 26, create website content data including the entirety of the streaming content, and store that website content data in the memory 22 with the appropriate related information in the database 40. The controller 20 will also encrypt that particular website content data to make that website content data inaccessible without a decryption key. Thus, only authorized users are permitted to access the encrypted website content data.

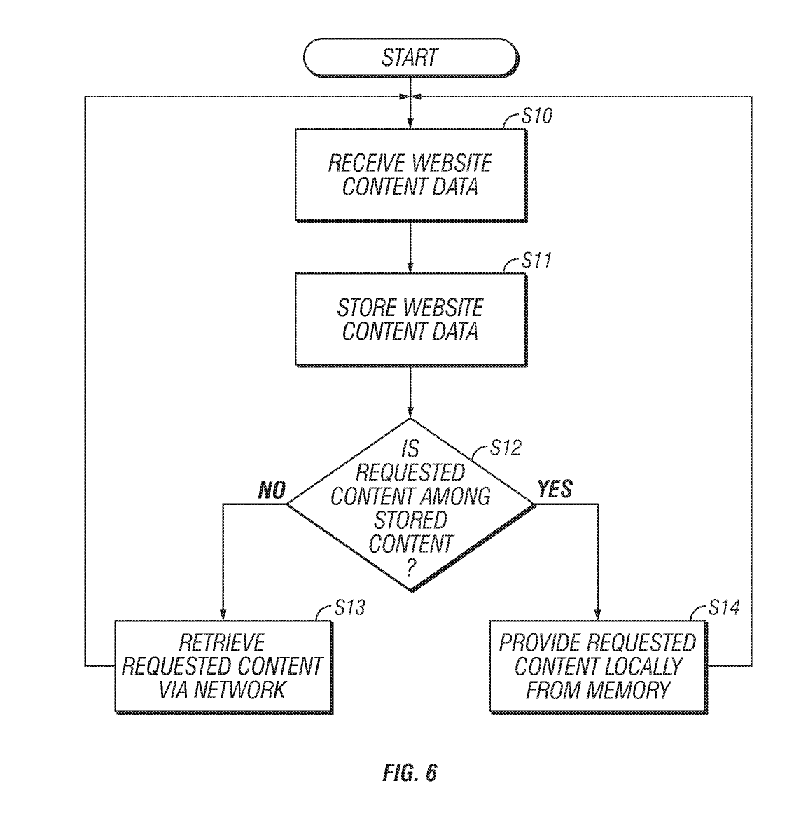

In step S4, the controller 20 controls the transceiver 18 to transmit (e.g., push) the website content data discussed above to the plurality of satellite user terminals 24 via a broadcast communication as understood in the art. That is, the controller 20 controls the transceiver 18 to transmit the website content data to the satellite 14 in a single broadcast transmission so that the satellite 14 will broadcast the content data to a plurality of satellite user terminals 24 in the single broadcast transmission. The controller 20 can further include in the website content data a local access indicator that indicates to local servers 38 at the satellite user terminals 24 that the local servers 38 are to make the website content data available to users from the local servers 38 as described below with regard to the flowchart in FIG. 6. When the transceiver 32 of a satellite user terminal 24 receives the broadcasted website content data, the controller 34 of the satellite user terminal 24 controls the memory 36 to store the website content data. Furthermore, the controller 34 controls the satellite user terminal 24 to make the website content data available to the user as discussed in detail below with regard to the flowchart in FIG. 6.

It should be further noted that the controller 20 can include satellite user terminal identification information in the website content data, such as in the headers of the packets of the website content data or in any other suitable manner. The satellite user terminal identification information identifies the satellite user terminals 24 for which the website content data is intended. For example, if certain satellite user terminals 24 have made requests for periodic updates of specific website content data, the controller 20 will include satellite user terminal identification information in that specific website content data. Therefore, when that specific website content data is included in the broadcast transmission, the controllers 34 of those certain satellite user terminals 24 receiving that specific website content data can store that specific content data in their associated memories 36. Controllers 34 of other satellite user terminals 24 receiving that specific website content data can, for example, chose to also store that specific website content data in their associated memories 36, or simply chose to ignore that specific website content data as understood in the art with regard to typical broadcast-type messaging. Likewise, for website content data of a known popular website, the controller 20 can include in that website content data the satellite user terminal identification information for every satellite user terminal 24 within the broadcast region. Therefore, the controllers 34 of every satellite user terminal 24 receiving the broadcast transmission can store that website content data in their associated memories 36. Naturally, the controller 20 can include satellite user terminal identification information in any of the website content data as desired to specifically target delivery to certain satellite user terminals 24 based on, for example, locations of the satellite user terminals 24, request histories of the satellite user terminals 24 and for any other suitable reason as understood by one skilled in the communication arts. In addition, the gateway 12 can transmit certain website content data to the satellite 14 for unicasting to one or more satellite user terminals 24 periodically as desired as understood in the art.

In step S5 of the flowchart shown in FIG. 2, the controller 20 controls the gateway 12 to update the website content data and the link accessible data from the respective content providers 26. The controller 20 therefore updates the website content data in the database 40 to include the most up-to-date information that is being provided by the content providers 26. For instance, as understood in the art, content providers 26 often update the content of certain websites every several minutes, such as every 5 minutes. Therefore, the website content data in the database 40 includes up-to-date information when the website content data is transmitted to the plurality of satellite user terminals 24 via a broadcast communication as steps Si through S4 discussed above are repeated.

It should also be noted that when step S1 is repeated, the controller 20 updates the information in the database 40 based on the request for websites as discussed above. Therefore, when the controller 20 analyzes the information in the database 40 during step S2, the controller 20 may determine that certain websites no longer meet the popularity condition as discussed above. Also, the controller 20 may determine that different websites now meet the popularity condition. In this event, the controller 20 will perform step S3 in the manner described above with regard to these different websites. Hence, the controller 20 will create respective website content data for each of these respective different websites in the manner discussed above. Also, the controller 20 will control the transceiver 18 to transmit the website content data for these different websites to the plurality of satellite user terminals 24 via a broadcast communication, while omitting from the broadcast the website content data of those websites which are determined to no longer meet the popularity condition. Accordingly, the gateway 12 provides the satellite user terminals 24 with periodic updates of the websites meeting the popularity condition on basically a real time or almost a real time basis.

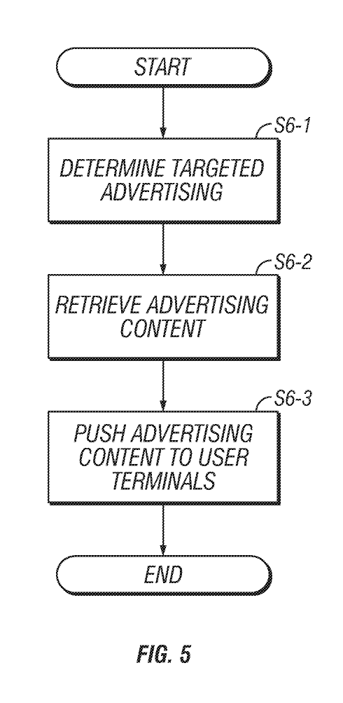

In addition, in step S6 of the flowchart shown in FIG. 2, the controller 20 optionally can perform advertising operations to transmit advertising content to a plurality of satellite user terminals 24 via a broadcast communication as will now be discussed with regard to the flowchart shown in FIG. 5. The controller 20 will then repeat operations S1 through S6 (or operations S1 through S5 if operation S6 is not performed) as discussed above.

Examples of advertising operations that are performed by the controller 20 will now be described. In operation S6-1, the controller 20 analyzes the information stored in the database 40, such as website request histories, to assess a respective website searching habit and interest for each satellite user terminal 24 to determine targeted advertisement potential. Thus, the controller 20 analyzes website access request activity by the satellite user terminals 24 to identify a respective interest characteristic associated with each of the satellite user terminals 24. Alternatively or in addition, the controller 20 can identify interest characteristics for each of the satellite user terminals 24 based on respective locations of the satellite user terminals 24 or other advertising-related characteristics as understood in the art. Furthermore, a financially-interested entity, such as a company having a financial interest in the satellite communication network 10, can charge monetary costs to the advertising entities (e.g., the companies whose products and/or services are being advertised) for the advertising services provided by the satellite communication network 10 and, in particular, the gateway 12 as described herein. Alternatively or in addition, the providers of the website content can charge monetary costs to the advertising entities. In any event, the satellite communication network 10 can accommodate any suitable fee-based advertising arrangement as understood in the art.

In step S6-2 control the transceiver to retrieve advertising content based on the interest characteristic from advertising sources, such as certain content providers 26. In step S6-3, the controller 20 controls the transceiver 18 to transmit, via a broadcast communication, the advertising content to the satellite 14 for broadcast to the plurality of remote locations associated with the interest characteristic in a broadcast communication. Alternatively or in addition, the controller 20 can include the advertising content in the broadcast communication performed in step S4 discussed above. For instance, the controller 20 can include the advertising content in the website content data which is transmitted to the satellite user terminals 24 via the broadcast communication in step S4. Also, the controller 20 can control the transceiver 32 to transmit certain advertising content to the satellite 14 for unicasting to one or more satellite user terminals 24 as understood in the art.

When the transceiver 32 of a satellite user terminal 24 receives the broadcasted advertising content and/or the unicasted advertising content, the controller 34 of the satellite user terminal 24 controls the memory 36 to store the advertising content. Furthermore, the controller 34 controls the satellite user terminal 24 to make the advertising content available to the user as discussed in detail below with regard to the flowchart in FIG. 6.

Upon completing steps S6-1 through S6-3, the controller 20 then repeat operations S1 through S6 (or operations S1 through S5 if operation S6 is not again performed) as discussed above.

Examples of operations performed by a satellite user terminal 24 will now be described with regard to the flowchart in FIG. 6. The operations performed by the controller 34 at the gateway 12 and by the controllers 34 at the satellite user terminals 24 can be performed continuously and independently of one another as appropriate to achieve the operations described herein. Also, the operations can be performed in any suitable order as can be appreciated from the description herein.

In step S10, the controller 34 of a satellite user terminal 24 controls the transceiver 32 of the satellite user terminal 24 to receive the website content data that is transmitted via a broadcast communication and/or a unicast communication as discussed above. Also, a user can specifically request, via a GUI or in any other suitable manner, that specific websites be retrieved and stored locally in the memory 36 as understood in the art.

In step S11, the controller 34 of the satellite user terminal 24 controls the controls the memory 36 to store the website content data. Also, if advertising content is received by the transceiver 32 as discussed above, the controller 34 controls the memory 36 to store the advertising content during step S11 or at any other appropriate time. In addition, the controller 34 can encrypt the website content data stored in the memory 36 if necessary or desired. Naturally, the controller 34 can encrypt any content in the memory 36, such as the advertising content, and so on. Moreover, the controller 34 can store the previously encrypted website content data, such as streaming content data that was already encrypted at the gateway 12 as discussed above. Also, the controller 34 can chose to store certain website content data in the associated memory 36, or ignore certain received website content data, based on the terminal identification information included in or associated with the website content data by the controller 20 of the gateway 12 as discussed above and as understood in the art.

In addition, the controller 20 can store the website content data in a particular manner based on characteristics of the website content data. For example, if the website content data includes a local access indicator as discussed above which indicates that the local servers 38 are to make the website content data available to users, the controller 20 can store that website content data at a particular location in the memory 36 and with an indication that such website content data is to be made available from the associated local server 38. Naturally, the controller 20 can store the website content data in the memory 36 in any suitable manner as understood in the art.

In step S12, when the controller 34 receives a request for a website from a user via, for example, a GUI such as a web browser, the controller 34 determines whether the website content could be provided locally by the server 38. For example, when a website request is received, the controller 34 can automatically first search the memory 36 to determine whether the website content is stored in the memory 36. Also, the controller 34 can maintain a list in memory of the website content that is currently stored in the memory 36. Thus, the storing and accessing of the website content to and from the memory by the controller 34 can be performed in any suitable manner as understood in the art.

If the controller 34 determines that the website content is not stored in the memory 36, the processing by the controller 34 proceeds to step S13 to control the transceiver 32 to attempt to retrieve the website content from the satellite communication network 10. That is, as discussed above, the transceiver 32 will transmit a request to the satellite 14 to be delivered to the gateway 12, and the gateway 12 will retrieve the website content from the content provider 26. The gateway 12 will therefore transmit the content to the satellite 14 which will transmit the content to the transceiver 32. The controller 34 can then store the content in memory 36 and provide the content to the user via the GUI in any suitable manner as understood in the art.

However, if the controller 34 determines in step S12 that the website content is stored in the memory 36, the processing by the controller 34 proceeds to step S14 where the controller 34 controls the server 38 of satellite user terminal 24 to provide the website content data from the memory 36 to, for example, the GUI without accessing the communication network 10. If necessary, the controller 34 decrypts the encrypted website content data in response to a key received via, for example, the GUI, to provide the website content data from the memory 36 in any suitable manner as understood in the art. Thus, the server 38 can even provide streaming content without accessing the communication network 10, since the streaming content is stored in its entirety in the memory 36. Also, if any advertising content associated with the content is stored in the memory 36, the controller 34 can control the server 38 to provide the advertising content from the memory 36 to, for example, the GUI without accessing the satellite communication network 10. Naturally, as understood in the art, the controller 34 can control the server 38 to provide content stored in the memory 36 to the GUI, while also controlling the transceiver 32 to request from the gateway 12 other content that not stored in the memory 36. The processing repeats and continues as discussed above.

As can be appreciated from the description herein, the satellite communication network 10 at least reduces the satellite communication latency, especially with regard to popular websites, since the contents of those websites, including content accessible via popular links on those websites, since the website content and the link accessible content are preloaded and stored locally at the servers 38 of the satellite user terminals 34. Also, bandwidth of the satellite communication network 10, especially the bandwidth used for communication between the satellite communication terminals 24 and the satellites 14, is used efficiently because popular websites are broadcasted to multiple satellite communication terminals 24 periodically by the gateway 12 via the satellite 14 without the need for repetitive, individual website requests from each of the satellite communication terminals 24 for those popular websites. Furthermore, delays in loading of the website content by the GUI can be reduced since the latency is reduced.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also, the term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A communication network comprising:
a gateway transceiver configured to communicate with a plurality of remote locations via the communication network; and
a gateway controller configured to generate website content data based on website data for a website and link accessible data at the website, and control the gateway transceiver to transmit the website content data to the plurality of remote locations via a broadcast communication.

2. The communication network according to claim 1, wherein
the gateway controller is configured to periodically update the website content data by generating updated website content data based on updated website data for the website and updated link accessible data at the website, and control the gateway transceiver to transmit the updated website content data to the plurality of remote locations via a broadcast communication.

3. The communication network according to claim 1, wherein
the gateway controller is configured to generate a plurality of website content data, each based on respective website data for a website and respective link accessible data at the website, and control the gateway transceiver to transmit the plurality of website content data to the plurality of remote locations via a broadcast communication.

4. The communication network according to claim 1, wherein
the gateway controller is further configured to include in the website content data a local access indicator that indicates to local terminals at the remote locations that the local terminals are to make the website content data available to users from the local terminals.

5. The communication network according to claim 1, wherein
the gateway controller is further configured to analyze website access request activity by the remote locations to identify an interest characteristic associated with the remote locations, control the transceiver to retrieve advertising content based on the interest characteristic, and control the transceiver to transmit, via a broadcast communication, the advertising content to the plurality of remote locations associated with the interest characteristic.

6. The communication network according to claim 1, wherein
the gateway controller is further configured to include encryption information in the website content data to restrict access to the website content data at the remote locations.

7. The communication network according to claim 1, wherein
the gateway transceiver is configured to establish a satellite communication link to communicate with the plurality of remote locations via the communication network.

8. The communication network according to claim 1, further comprising
a plurality of local terminals disposed at the remote locations, each of the local terminals being configured to access a storage that is configured to store the website content data transmitted to the remote locations by the gateway transceiver.

9. The communication network according to claim 8, wherein
each of the local terminals is configured to provide the website content data from the storage without accessing the communication network in response to receiving a request for the website.

10. The communication network according to claim 1, wherein
the controller is configured to identify the website data based on a popularity condition relating to information pertaining to requests for access to the website data.

11. A method for operating a communication network, comprising:
operating a gateway in the communication network to generate website content data based on website data for a website and link accessible data at the website; and
operating the gateway to transmit the website content data to the plurality of remote locations via a broadcast communication.

12. The method according to claim 11, further comprising
operating the gateway to periodically update the website content data by generating updated website content data based on updated website data for the website and updated link accessible data at the website; and
operating the gateway transceiver to transmit the updated website content data to the plurality of remote locations via a broadcast communication.

13. The method according to claim 11, further comprising
operating the gateway to generate a plurality of website content data, each based on respective website data for a website and respective link accessible data at the website; and
operating the gateway to transmit the plurality of website content data to the plurality of remote locations via a broadcast communication.

14. The method according to claim 11, further comprising
operating the gateway to analyze website access request activity by the remote locations to identify an interest characteristic associated with the remote locations, and to retrieve advertising content based on the interest characteristic; and
operating the gateway to transmit, via a broadcast communication, the advertising content to the plurality of remote locations associated with the interest characteristic.

15. The method according to claim 11, wherein
the operating of the gateway to transmit the website content data includes establishing a satellite communication link over which to transmit the website content data to the plurality of remote locations.

16. The method according to claim 11, further comprising
storing the website content data transmitted to the remote locations in a respective storage associated with a respective network user terminal disposed at each of the remote locations; and
operating a local server at the local user terminal to provide the website content data from its storage without accessing the gateway in response to receiving a request for the website.

17. The method according to claim 1, further comprising
operating the gateway to identify the website data based on a popularity condition relating to information pertaining to requests for access to the website data.

18. A communication network user terminal comprising:
a transceiver configured to communicate with a gateway via a communication network; and
a controller configured to control the transceiver to receive website content data provided from the gateway via a transmit broadcast over the communication network and to control a storage to store the website content data, the website content data having been generated by the gateway based on website data for a website and link accessible data at the website;
the controller being further configured to provide the website content data from the storage, without controlling the transceiver from communicating with the communication network, in response to receiving a request for the website.

19. The communication network user terminal according to claim 18, wherein
the controller is further configured to control the transceiver to receive advertising content provided from the gateway via a transmit broadcast over the communication network and to control the storage to store the advertising content, the advertising content having been retrieved by the gateway based on an interest characteristic associated with the communication network user terminal; and
the controller is further configured to provide the advertising content from the storage, without controlling the transceiver from communicating with the communication network, in response to receiving a request for the website.

20. The communication network user terminal according to claim 18, wherein
the controller is further configured to store the website content data as encrypted website content data in the storage, and to decrypt the encrypted website content data in response to a key to provide the website content data from the storage.
